(19) United States
(12) Patent Application Publication
(10) Pub. No.: US 2013/0202974 A1
(43) Pub. Date: Aug. 8, 2013

(54) AIR CATHODE, METAL-AIR BATTERY AND METHOD FOR PRODUCING AIR CATHODE FOR METAL-AIR BATTERY

(71) Applicant: Fuminori Mizuno, Susono-shi (JP)

(72) Inventor: Fuminori Mizuno, Susono-shi (JP)

(21) Appl. No.: 13/814,827

(22) PCT Filed: Aug. 23, 2010
(86) PCT No.: PCT/JP2010/064177

§ 371 Date: Apr. 22, 2013

(51) Int. Cl. H01M 12/06

(52) U.S. Cl. CPC H01M 12/06
USPC 429/405; 29/623.1

(57) ABSTRACT

An object of the present invention is to provide a metal-air battery having excellent durability and capacity by facilitating a reaction of oxygen radicals and metal ions at an air cathode.

Disclosed are an air cathode used for a metal-air battery comprising an air cathode, an anode and an electrolyte layer which is present between the air cathode and the anode and which conducts metal ions between the air cathode and the anode, wherein the air cathode comprises an air cathode layer comprising at least an electroconductive material and a supporting electrolyte salt, a metal-air battery comprising the air cathode, and a method for producing the air cathode for the metal-air battery.

### TECHNICAL FIELD

The present invention relates to an air cathode for a metal-air battery, a metal-air battery comprising the air cathode, and a method for producing the air cathode for the metal-air battery.

### BACKGROUND ART

A metal-air battery comprising an air cathode and an anode can charge and discharge the battery by conducting a redox reaction of oxygen at the air cathode and a redox reaction of metal contained in the anode at the anode. Since the metal-air battery uses air (oxygen) as a cathode active material, it has advantages in high energy density and easiness to downsize and reduce weight. Therefore, the metal-air battery receives attention as a high-capacity secondary battery exceeding the lithium secondary battery which has been widely used. As the metal-air battery, for example, a lithium-air battery, a magnesium-air battery and a zinc-air battery are known.

Such a metal-air battery comprises, for example, an air cathode layer containing an electroconductive material, a catalyst and a binder, an air cathode current collector collecting current of the air cathode layer, an anode layer comprising metal or an alloy, an anode current collector collecting current of the anode layer, and an electrolyte present between the air cathode layer and the anode layer.

For example, it is considered that in a metal-air battery in which conducting ions are monovalent metal ions, the charge-discharge reaction described below proceeds. In the following formulae, “M” refers to metal species.

### [Discharging]

M→M⁺+e⁻ Anode:

2M⁺+O₂+2e⁻→M₂O₂ Cathode:

### [Charging]

M⁺+e⁻→M Anode:

M₂O₂→2M+O₂+2e⁻ Cathode:

While the metal-air battery has advantages as described above, it has disadvantages to be solved such as improving charge-discharge cycling performance and capacity.

For example, Patent Literature 1 discloses techniques intended to provide an air battery having excellent cycle performance and discharged capacity by preventing the volatilization of a liquid electrolyte around a cathode carbon surface. In particular, Patent Literature 1 discloses a non-aqueous electrolyte battery comprising an anode capable of releasing metal ions, a cathode comprising a carbon material, a non-aqueous liquid electrolyte which is present between the anode and the cathode and which contains an organic carbonate compound having a (—O—(C═O)—O—) structure, and a battery case provided with an air hole for taking up oxygen into the cathode, wherein the carbon material surface of the cathode is covered with a film of decomposition products of the organic carbonate compound.

### CITATION LIST

### Patent Literature

Patent Literature 1: Japanese Patent Application Laid-Open (JP-A) No. 2003-100309

### SUMMARY OF INVENTION

### Technical Problem

The inventor of the present invention has studied the conventional metal-air battery, especially for the metal-air battery (lithium-air secondary battery) disclosed in Patent Literature 1, and has found out that an organic carbonate compound is produced on the air cathode (cathode) for every discharge, and battery resistance is increased and battery capacity is decreased by the repetition of charge and discharge, thereby decreasing a battery lifetime. This is considered because a high-resistance decomposition product (organic carbonate compound) is produced by the reaction of oxygen radicals produced at the air cathode and an organic solvent in a liquid electrolyte.

The present invention was made in view of the above circumstances, and it is an object of the present invention to provide a metal-air battery having excellent durability and capacity by facilitating a reaction of oxygen radicals and metal ions at an air cathode.

### Solution to Problem

The air cathode of the present invention is an air cathode used for a metal-air battery comprising an air cathode, an anode and an electrolyte layer which is present between the air cathode and the anode and which conducts metal ions between the air cathode and the anode,

wherein the air cathode comprises an air cathode layer comprising at least an electroconductive material and a first supporting electrolyte salt.

Since the air cathode for the metal-air battery of the present invention contains a supporting electrolyte salt, the metal ion concentration of the air cathode for the metal-air battery of the present invention is higher than that of the conventional air cathode. Therefore, upon discharging the metal-air battery, a reaction of oxygen radicals and metal ions at the air cathode facilitates, so that a metal oxide is efficiently produced. Thereby, the progression of a side reaction of the oxygen radicals, for example, a reaction of the oxygen radicals and an organic solvent, etc. contained in the liquid electrolyte of the electrolyte layer, is inhibited. Accordingly, the present invention can improve capacity and durability of the metal-air battery.

As a specific embodiment of the air cathode of the present invention, there can be exemplified an air cathode,

wherein the electrolyte layer comprises a liquid electrolyte comprising a second supporting electrolyte salt, and

wherein the air cathode layer contains 0.05 to 2.5 mol of the first supporting electrolyte salt with respect to 1 L of the liquid electrolyte contained in the electrolyte layer.

By setting the content of the first supporting electrolyte salt in the air cathode layer within the above range, it is possible to obtain the effect of improving capacity and durability of the metal-air battery while ensuring electrical conductivity of the air cathode layer.

The metal-air battery of the present invention is a metal-air battery comprising an air cathode, an anode and an electrolyte layer which is present between the air cathode and the anode and which conducts metal ions between the air cathode and the anode,

wherein the air cathode comprises an air cathode layer comprising at least an electroconductive material and a first supporting electrolyte salt, and

wherein the electrolyte layer comprises a liquid electrolyte comprising a second supporting electrolyte salt.

The metal-air battery of the present invention comprises the above described air cathode of the present invention, so that it has excellent capacity and high durability.

In the metal-air battery of the present invention, the air cathode layer preferably contains 0.05 to 2.5 mol of the first supporting electrolyte salt with respect to 1 L of the liquid electrolyte contained in the electrolyte layer, and the electrolyte layer preferably contains 0.5 to 1.2 mol of the second supporting electrolyte salt with respect to 1 L of the liquid electrolyte contained in the electrolyte layer. This is because there can be inhibited an increase in battery resistance while improving durability and capacity.

In this case, it is further preferable that the total amount of the first supporting electrolyte salt contained in the air cathode layer and the second supporting electrolyte salt contained in the electrolyte layer [(the molar number of the first supporting electrolyte salt)+(the molar number of the second supporting electrolyte salt)] is 0.6 to 3.0 mol, with respect to 1 L of the liquid electrolyte contained in the electrolyte layer.

The method for producing the air cathode for the metal-air battery, comprises the steps of:

preparing an air cathode material mixture by mixing at least a supporting electrolyte salt, an electroconductive material and a solvent; and

evaporating to dryness of the supporting electrolyte salt by drying the air cathode material mixture.

According to the production method of the present invention, it is possible to produce an air cathode layer in which a supporting electrolyte salt is uniformly dispersed.

### Advantageous Effects of Invention

According to the present invention, it is possible to improve durability and capacity of the metal-air battery by facilitating a reaction of oxygen radicals and metal ions at an air cathode.

### BRIEF DESCRIPTION OF DRAWINGS

FIG. 1 is a sectional view showing an embodiment of a metal-air battery of the present invention.

FIG. 2 is a graph showing constant current charge-discharge curves in Examples.

FIG. 3 is a graph showing charge-discharge cycling performance in Examples and Comparative Example.

### DESCRIPTION OF EMBODIMENTS

Hereinafter, there will be described the air cathode for the metal-air battery of the present invention, the method for producing the air cathode for the metal-air battery of the present invention, and the metal-air battery of the present invention.

In the present invention, the metal-air battery refers to a battery comprising an air cathode (cathode) in which a redox reaction of oxygen being a cathode active material is conducted, an anode in which a redox reaction of metal is conducted, and an electrolyte layer which is present between the air cathode and the anode and which conducts metal ions. Examples of the metal-air battery include a lithium-air battery, a sodium-air battery, a potassium-air battery, a magnesium-air battery, a calcium-air battery, a zinc-air battery and an aluminum-air battery.

In the present invention, the air-metal battery can be a primary battery or a secondary battery, and the secondary battery is preferable since the effects of the present invention such as cycling performance, etc. can be sufficiently exerted.

### 1. Air Cathode for Metal-Air Battery and Method for Producing the Same

The air cathode of the present invention is an air cathode comprising an air cathode, an anode and an electrolyte layer which is present between the air cathode and the anode and which conducts metal ions between the air cathode and the anode,

wherein the air cathode comprises an air cathode layer comprising at least an electroconductive material and a first supporting electrolyte salt.

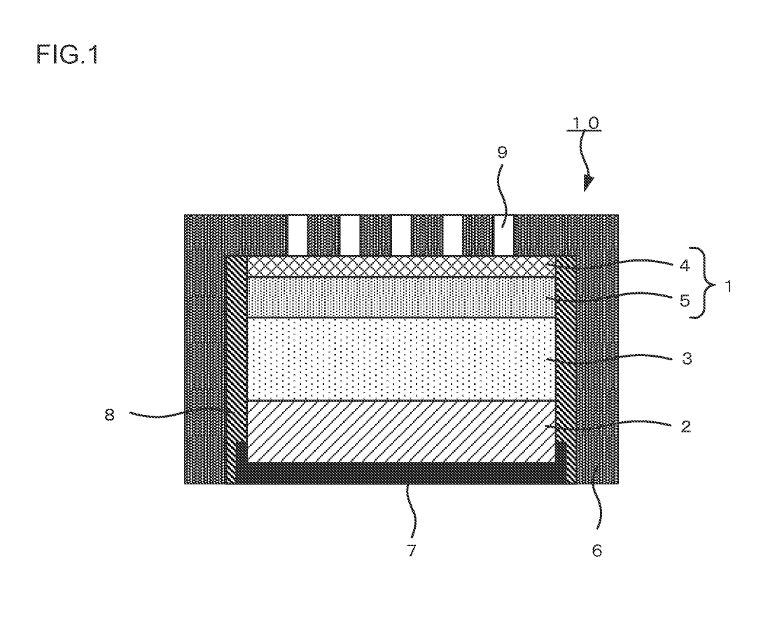

FIG. 1 shows an embodiment of the metal-air battery comprising the air cathode of the present invention.

In FIG. 1, metal-air battery 10 is constituted with air cathode (cathode) 1 using oxygen as an active material, anode 2 comprising metal (for example, Li metal) and electrolyte layer 3 conducting metal ions between air cathode 1 and anode 2, and these are housed in a battery case constituted with air cathode can 6 and anode can 7. Air cathode can 6 and anode can 7 are immobilized with gasket 8, thereby ensuring sealing performance in the battery case.

Air cathode 1 comprises air cathode layer 5 and air cathode current collector 4 collecting current of air cathode layer 5. Air cathode layer 5 is a redox reaction field of oxygen and contains an electroconductive material (for example, carbon black), a catalyst (for example, manganese dioxide), a supporting electrolyte salt (for example, a Li salt) and a binder (for example, polyvinylidene fluoride). Air cathode current collector 4 comprises an electroconductive material having a porous structure (for example, a metal mesh). Air taken from air hole 9 provided with air cathode can 6 is supplied to air cathode layer 5 through air cathode current collector 4.

Anode 2 comprises metal (for example, Li metal). That is, anode 2 contains an anode active material capable of releasing and storing metal ions being conducting ion species.

Electrolyte layer 3 contains a liquid electrolyte in which a supporting electrolyte salt (for example, a Li salt) is dissolved in an organic solvent (for example, dimethyl carbonate). A separator having insulation property and a porous structure is disposed between air cathode 1 and anode 2 (not shown in figure), and the liquid electrolyte is impregnated with the inside of the porous structure in the separator.

The air cathode of the present invention is an air cathode for a metal-air battery. The main feature of the air cathode of the present invention is that the air cathode has an air cathode layer containing a supporting electrolyte salt.

In the conventional metal-air battery, at the air cathode (cathode) upon discharging, metal ions (conducting ions) produced at the anode and transferred through the electrolyte layer are reacted with oxygen radicals produced from oxygen which is supplied to the air cathode, and then a metal oxide is produced. In this case, the air cathode has low reactivity of the oxygen radicals and the metal ions, so that a side reaction of materials other than the metal ions (for example, an organic solvent in a liquid electrolyte, etc.) and the oxygen radicals is likely to proceed. As a result of the reaction of the oxygen radicals and the organic solvent, a product having low electron conductivity is produced, thereby decreasing durability of the battery. In addition, capacity of the battery is decreased by the side reaction of the oxygen radicals.

To the contrary, in the air cathode of the present invention, upon discharging, in addition to metal ions produced at the anode and transferred from the anode, metal ions derived from the supporting electrolyte salt which is preliminarily contained in the air cathode layer are present. The supporting electrolyte salt contained in the air cathode layer is dissolved in a liquid (typically, a liquid electrolyte) contained in the electrolyte layer, and dissociates in the metal ions.

As described above, the air cathode of the present invention, upon discharging, has a high concentration of the metal ions, so that the reaction of oxygen radicals and the metal ions in the air cathode can be facilitated. Thereby, the reaction of materials other than metal ions (for example, a solvent in a liquid electrolyte, etc.) and oxygen radicals, which is caused at the air cathode of the conventional metal-air battery, can be inhibited. That is, according to the present invention, it is possible to improve capacity by inhibiting the side reaction of oxygen radicals, and to prevent a decrease in a battery lifetime, which is attributable to the products produced by the side reaction.

As a result of researches, the inventor of the present invention obtained the following knowledge: even if the concentration of the supporting electrolyte salt in the electrolyte layer is increased without preliminarily adding the supporting electrolyte salt in the air cathode, the effects of the present invention as described above are not obtained. In particular, there was obtained the result as shown in Example 3 and Comparative Example 1 described below: even if the total amounts of the supporting electrolyte salt contained in the air cathode and the electrolyte layer each in Example 3 and Comparative Example 1 are the same, significantly-higher discharged capacity can be maintained in Example 3 compared to Comparative Example 1. From the above result, it can be said that not by increasing the concentration of the supporting electrolyte salt in the electrolyte layer, but by adding the supporting electrolyte salt also to the air cathode as in the case of the present invention, it is possible to inhibit the progression of the side reaction of oxygen radicals as described above and to efficiently improve capacity and a battery lifetime.

In addition, it can be expected that the air cathode of the present invention exerts the effect of inhibiting dendrite at the anode, which is accompanied with charging and discharging.

Conventionally, it has been known that when metal is precipitated at the anode upon charging, the precipitated metal develops to dendrite (in the form of dendrite) to cause a decrease in battery capacity, short circuit, etc. In the conventional metal-air battery, upon charging, metal ions are produced by the decomposition of a metal oxide at the air cathode and transferred to the anode through the electrolyte layer, and then precipitated on the anode surface. Therefore, the concentration of the metal ions around the anode layer becomes higher with increasing the distance from the anode layer surface. Thereby, it is considered that metal is ununiformly precipitated according to concavity and convexity of the anode layer surface, that is, metal is more precipitated on convexity than concavity, so that metal crystal develops to dendrite.

The mechanism to inhibit dendrite by the air cathode of the present invention is considered as follows: in particular, in the metal-air battery comprising the air cathode of the present invention, in addition to the metal ions produced by the decomposition of the metal oxide at the air cathode, metal ions derived from the supporting electrolyte salt which is preliminarily contained in the air cathode are present around the anode surface upon charging. That is, the concentration of the metal ions on the anode surface upon charging can be increased compared to that of the conventional metal-air battery. Thereby, it is considered that it is possible to inhibit the progression of ununiform metal precipitation according to concavity and convexity of the anode layer surface as described above.

Hereinafter, the air cathode of the present invention will be described in detail.

The air cathode of the present invention comprises an air cathode layer containing at least an electroconductive material and the first supporting electrolyte salt. In the air cathode layer, oxygen (oxygen radicals) supplied is reacted with metal ions to produce a metal oxide on the electroconductive material surface. The air cathode layer generally has a porous structure, so that diffuseness of oxygen being an active material is ensured.

The electroconductive material is not particularly limited as long as it has electrical conductivity, and the examples include a carbon material. The carbon material may have a porous structure or not. Since a large number of reaction fields can be introduced into the air cathode, the carbon material preferably has a porous structure. Examples of the carbon material having the porous structure include mesoporous carbon. Examples of the carbon material having no porous structure include graphite, acetylene black, carbon nanotube and carbon nanofiber.

The content of the electroconductive material in the air cathode layer varies depending on its density and specific surface area, and it is preferably, for example, in the range of 10% by weight to 99% by weight.

The first supporting electrolyte salt is not particularly limited as long as it can conduct metal ions required to be conducted between the air cathode and the anode, and can be appropriately selected. In general, a metal salt containing metal ions required to be conducted can be used as the first supporting electrolyte salt.

For example, in the case of a lithium-air battery, a lithium salt can be used as the supporting electrolyte salt. Examples of the lithium salt include inorganic lithium salts such as LiPF₆, LiBF₄, LiClO₄, LiAsF₆, LiOH, LiCl, LiNO₃ and Li₂SO₄.

Also, organic lithium salts such as CH₃CO₂Li, and organic lithium salts represented by the following formulae (1) and (2) can be used.

Li(CₘF₂ₘ₊₁SO₃) Formula (1):

wherein “m” is 1 or more and 8 or less and preferably 1 or more and 4 or less.

LiN(CₙF₂ₘ₊₁SO₂)(CₚF₂ₚ₊₁SO₂) Formula (2):

wherein each of “n” and “p” is 1 or more and 8 or less, preferably 1 or more and 4 or less and may be the same or different from each other.

Examples of the organic lithium salt represented by Formula (1) include LiCF₃SO₃. Examples of the organic lithium salt represented by Formula (2) include LiN(CF₃SO₂)₂, LiN(C₂F₅SO₂)₂ and LiC(CF₃SO₂)₃.

In the case of the sodium-air battery, as the first supporting electrolyte salt, sodium salts such as NaI, NaSCN, NaBr, NaClO₄, NaPF₆ and NaTFSA [sodium bis(trifluoromethanesulfonyl)amide] can be used.

In the case of the potassium-air battery, as the first supporting electrolyte salt, potassium salts such as KClO₄, KSCN, KPF₆ and KTFSA [potassium bis(trifluoromethanesulfonyl)amide] can be used.

The first supporting electrolyte salt contained in the air cathode layer can be one kind or two or more kinds. Also, it can be the same or different from the supporting electrolyte salt contained in the electrolyte layer (second supporting electrolyte salt).

Especially in the case that the electrolyte layer which can be combined with the air cathode of the present invention comprises a liquid electrolyte comprising the second supporting electrolyte salt, the air cathode layer preferably contains 0.05 to 2.5 mol of the first supporting electrolyte salt with respect to 1 L of the liquid electrolyte contained in the electrolyte layer. This is because if the content of the first supporting electrolyte salt in the air cathode layer is 0.05 mol or more with respect to 1 L of the liquid electrolyte in the electrolyte layer, the effects of the present invention such as improving durability and capacity can be efficiently exerted, and if the content is 2.5 mol or less, electron conductivity of the air cathode layer can be sufficiently ensured. The amount of the first supporting electrolyte salt in the air cathode layer is more preferably 0.1 mol to 2.0 mol, and still more preferably 0.25 mol to 1.25 mol, with respect to 1 L of the liquid electrolyte.

The first supporting electrolyte salt can be uniformly contained throughout the air cathode layer, or the parts having different concentration of the first supporting electrolyte salt can be distributed on the air cathode layer.

For example, there can be exemplified the embodiment in which the concentration of the first supporting electrolyte salt on the supply side of oxygen, typically on the air cathode current collector side, is increased compared to that on the electrolyte layer side in the air cathode layer. As described above, by increasing the concentration of the supporting electrolyte salt on the supply side of oxygen, the reaction of oxygen radicals and metal ions can be efficiently facilitated. Further, by decreasing the concentration of the supporting electrolyte salt on the electrolyte layer side, the supporting electrolyte salt in the air cathode layer is prevented from excessively eluting into the electrolyte layer, so that the supporting electrolyte salt can be kept in the air cathode layer over a long time. Thereby, it is possible to obtain the effects of the present invention over a long time. To sufficiently exert such effects, the embodiment in which the supporting electrolyte salt is contained only in the supply side of oxygen of the air cathode layer, and the supporting electrolyte salt is not contained in the electrolyte layer side, is particularly preferable.

The air cathode layer can comprise a binder for fixing an electroconductive material and a catalyst described below, if necessary, since the electroconductive material and the catalyst can be fixed, thereby improving cycling performance.

Examples of the binder include polyvinylidene difluoride (PVDF), polytetrafluoroethylene (PTFE) and styrene-butadiene rubber (SBR).

The content of the binder in the air cathode layer is preferably, for example, 40% by weight or less, more preferably in the range of 1% by weight to 10% by weight.

The air cathode layer can comprise a catalyst which facilitates a redox reaction of oxygen in the air cathode. The catalyst is preferably supported by the electroconductive material since the aggregation of the catalyst is inhibited, thereby improving catalyst efficiency.

The catalyst is not particularly limited, and the examples include: phthalocyanine compounds such as cobalt phthalocyanine, manganese phthalocyanine, nickel phthalocyanine, tin phthalocyanine oxide, titanyl phthalocyanine and dilithium phthalocyanine; naphthocyanine compounds such as cobalt naphthocyanine; porphyrin compounds such as iron porphyrin; metal oxides such as MnO₂, CeO₂, Co₃O₄, NiO, V₂O₅, Fe₂O₃, ZnO, CuO, LiMnO₂, Li₂MnO₃, LiMn₂O₄, Li₄Ti₅O₁₂, Li₂TiO₃, LiNi_{1/3}Co_{1/3}Mn_{1/3}O₂, LiNiO₂, LiVO₃, Li₅FeO₄, LiFeO₂, LiCrO₂, LiCoO₂, LiCuO₂, LiZnO₂, Li₂MoO₄, LiNbO₃, LiTaO₃, Li₂WO₄, Li₂ZrO₃, NaMnO₂, CaMnO₃, CaFeO₃, MgTiO₃ and KMnO₂; and noble metals such as Pt, Ag and Au.

The content of the catalyst in the air cathode layer is preferably, for example, in the range of 1% by weight to 90% by weight.

The air cathode can further comprise an air cathode current collector collecting current of the air cathode layer in addition to the air cathode layer.

The air cathode current collector can have a porous structure or a dense structure as long as it has desired electron conductivity. From the viewpoint of diffuseness of air (oxygen), the air cathode current collector having the porous structure is preferable. Examples of the porous structure include: a mesh structure in which constituent fibers are regularly aligned; a structure of non-woven fabric in which constituent fibers are randomly aligned; and a three-dimensional network structure having closed pores or continuous pores. The porosity of the current collector having the porous structure is not particularly limited, and is preferably in the range of 20 to 99%.

In the case of using the air cathode current collector having the porous structure, unlike FIG. 1 in which the air cathode layer and the air cathode current collector are laminated (adjacent), the air cathode current collector can be provided inside the air cathode layer. If the air cathode current collector is provided inside the air cathode layer, there could be expected the effect of improving current collection efficiency of the air cathode.

Examples of the material of the air cathode current collector include: metal materials such as stainless, nickel, aluminum, iron, titanium and copper; carbon materials such as carbon fiber; and high electron-conductive ceramic materials such as titanium nitride. In particular, the current collector using carbon materials is preferable from the viewpoint of corrosion resistance since the elution of the porous current collector is inhibited when a strong alkaline metal oxide is produced by a discharge reaction in the air cathode, so that it is possible to inhibit a decrease in battery performance caused by the elution.

The thickness of the air cathode current collector is not particularly limited, and is preferably, for example, in the range of 10 μm to 1,000 μm, more preferably in the range of 20 to 400 μm.

In the metal-air battery, the battery case described below can have a function as the current collector of the air cathode.

The thickness of the air cathode varies depending on the intended use of the metal-air battery, and is preferably, for example, in the range of 2 μm to 500 μm, more preferably in the range of 5 μm to 300 μm.

The method for producing the air cathode for the metal-air battery of the present invention is not particularly limited. As a preferred example, there can be exemplified a method comprising the steps of: preparing an air cathode material mixture by mixing at least a supporting electrolyte salt (a first supporting electrolyte salt), an electroconductive material and a solvent; and evaporating to dryness of the supporting electrolyte salt by drying the air cathode material mixture. As the method described above, by mixing the supporting electrolyte salt with other constitutional materials of the air cathode layer such as the electroconductive material in the state that the supporting electrolyte salt is dissolved in the solvent and then recrystalizing the supporting electrolyte salt, the air cathode layer in which the supporting electrolyte salt is uniformly dispersed can be produced. After drying the air cathode material mixture, a pressure treatment or a heat treatment can be further performed thereon, if necessary.

By applying the air cathode material mixture on the surface of the air cathode current collector followed by drying the same, the air cathode in which the air cathode layer and the air cathode current collector are stacked can be produced. Alternatively, by stacking the air cathode current collector on the air cathode layer obtained by applying and drying the air cathode material mixture followed by appropriately applying pressure and heat, the air cathode in which the air cathode layer and the air cathode current collector are stacked can be produced.

The solvent in the air cathode material mixture is not particularly limited as long as it is a volatile solvent, and can be appropriately selected. Specific examples of the solvent include acetone, N,N-dimethylformamide (DMF) and N-methyl-2-pyrolidone (NMP). Since the air cathode material mixture can be easily dried, the solvent having a boiling point of 200° C. or less is preferable.

The method for applying the air cathode material mixture is not particularly limited, and general methods such as a doctor blade method and a spray method can be used.

### 2. Metal-Air Battery

The metal-air battery of the present invention is a metal-air battery comprising an air cathode, an anode and an electrolyte layer which is present between the air cathode and the anode and which conducts metal ions between the air cathode and the anode,

wherein the air cathode comprises an air cathode layer comprising at least an electroconductive material and a first supporting electrolyte salt, and

wherein the electrolyte layer comprises a liquid electrolyte comprising at least a second supporting electrolyte salt.

The metal-air battery shown in FIG. 1 is an embodiment of the metal-air battery of the present invention. The explanation of the metal-air battery in FIG. 1 is omitted here since the metal-air battery is explained above.

The metal-air battery of the present invention comprises the above-described air cathode for the metal-air battery of the present invention, so that it is possible to inhibit a side reaction of oxygen radicals, i.e. a reaction of materials other than metal ions (for example, a solvent in a liquid electrolyte, etc.) and oxygen radicals. Therefore, the metal-air battery of the present invention can exhibit excellent capacity by inhibiting the side reaction and inhibit a decrease in a battery lifetime, which is attributable to the products produced by the side reaction. In addition, in the metal-air battery of the present invention comprising the air cathode, there can be expected the effect of inhibiting dendrite at the anode accompanying charging and discharging by the reason described above.

The intended use of the metal-air battery of the present invention is not particularly limited, and the examples include a power source equipped on a vehicle, a stationary power source and a household power source.

Hereinafter, there will be described the anode and the electrolyte layer among the components of the metal-air battery of the present invention. The explanation for the air cathode is omitted here since it is the same as the air cathode of the present invention described above.

### (Anode)

The anode comprises an anode layer comprising an anode active material capable of releasing and storing metal ions. The anode generally comprises an anode current collector collecting current of the anode layer in addition to the anode layer.

The anode active material is not particularly limited as long as it can release and store metal ions, and the examples include an elemental metal, an alloy, a metal oxide, a metal sulfide and a metal nitride, all of which contain metal ions being conducting ions. A carbon material can be also used as the anode active material. As the anode active material, preferred is an elemental metal or an alloy, more preferred is an elemental metal.

Specific examples of the anode active material of the lithium-air battery include: a lithium metal; a lithium alloy such as a lithium-aluminum alloy, a lithium-tin alloy, a lithium-lead alloy and a lithium-silicon alloy; a metal oxide such as a tin oxide, a silicon oxide, a lithium titanium oxide, a niobium oxide and a tungsten oxide; a metal sulfide such as a tin sulfide and a titanium sulfide; a metal nitride such as a lithium cobalt nitride, a lithium iron nitride and a lithium manganese nitride; and a carbon material such as graphite. Among them, preferred are a lithium metal and a carbon material, more preferred is a lithium metal from the viewpoint of increase in capacity.

The anode layer can comprise at least an anode active material, and if necessary, it can comprise a binder to fix the anode active material. For example, when a metal or alloy in a foil form is used as the anode active material, the anode layer can be an embodiment comprising the anode active material only. When an anode active material in a powder form is used, the anode layer can be an embodiment comprising the anode active material and a binder. Also, the anode layer can comprise an electroconductive material. Explanation of types and used amount of the binder and the electroconductive material is omitted here since they are the same as ones in the above-mentioned air cathode.

The material of the anode current collector is not particularly limited as long as it has electrical conductivity. Examples of the material include copper, stainless and nickel. Examples of the form of the anode current collector include a foil form, a plate form and a mesh form. A battery case can also function as an anode current collector.

The method for producing the anode is not particularly limited. For example, there can be exemplified a method comprising the steps of: stacking the anode active material in the foil form and anode current collector; and applying a pressure thereon. As another method, there can be exemplified a method comprising the steps of: preparing an anode material mixture containing an anode active material and a binder; and applying thus obtained mixture on the anode current collector followed by drying the same.

### (Electrolyte Layer)

The electrolyte layer comprises a liquid electrolyte comprising a second supporting electrolyte salt, and conducts metal ions between an air cathode and an anode. Liquid components, typically a non-aqueous solvent described below and water, of the liquid electrolyte contained in the electrolyte layer facilitate the dissociation of metal ions of a supporting electrolyte salt (the first supporting electrolyte salt) contained in the air cathode layer, and further facilitate the transfer of the metal ions derived from the above supporting electrolyte salt into the anode layer.

Examples of the liquid electrolyte include a non-aqueous liquid electrolyte and an aqueous liquid electrolyte. In the case of the aqueous liquid electrolyte, the anode has to be protected. The protection method of the anode is not particularly limited, and a general method can be employed.

The non-aqueous liquid electrolyte is a solution in which a supporting electrolyte salt (the second supporting electrolyte salt) is dissolved in a non-aqueous solvent.

The non-aqueous solvent is not particularly limited, and the examples include propylene carbonate (PC), ethylene carbonate (EC), vinylene carbonate, dimethyl carbonate (DMC), ethyl methyl carbonate (EMC), diethyl carbonate (DEC), methyl propyl carbonate, isopropyl methyl carbonate, ethyl propionate, methyl propionate, y-butyrolactone, ethyl acetate, methyl acetate, tetrahydrofuran, 2-methyltetrahydrofuran, ethyleneglycol dimethylether, ethyleneglycol diethylether, acetonitrile, dimethylsulfoxide, diethoxyethane and dimethoxyethane.

An ionic liquid can be used as the non-aqueous solvent. Examples of the ionic liquid include aliphatic quaternary ammonium salts such as N,N,N-trimethyl-N-propylammonium bis(trifluoromethanesulfonyl)amide (TMPA-TFSA), N-methyl-N-propylpiperidinium bis(trifluoromethanesulfonyl)amide (PP13-TFSA), N-methyl-N-propylpyrrolidinium bis(trifluoromethanesulfonyl)amide (P13-TFSA), N-methyl-N-butylpyrrolidinium bis(trifluoromethanesulfonyl)amide (P14-TFSA) and N,N-diethyl-N-methyl-N-(2-methoxyethyl)ammonium bis(trifluoromethanesulfonyl)amide (DEME-TFSA); and alkyl imidazolium quanternary salts such as 1-methyl-3-ethylimidazolium tetrafluoroborate (EMIBF₄), 1-methyl-3-ethylimidazolium bis(trifluoromethanesulfonyl)imide (EMITFSI), 1-allyl-3-ethylimidazolium bromide (AEImBr), 1-allyl-3-ethylimidazolium tetrafluoroborate (AEImBF₄), 1-allyl-3-ethylimidazolium bis(trifluoromethanesulfonyl)amide (AEImTFSA), 1,3-diallylimidazolium bromide (AAImBr), 1,3-diallylimidazolium tetrafluoroborate (AAImBF₄) and 1,3-diallylimidazolium bis(trifluoromethanesulfonyl)amide (AAImTFSA).

The non-aqueous solvent contained in the non-aqueous liquid electrolyte can be one kind or two or more kinds.

The second supporting electrolyte salt used for the non-aqueous liquid electrolyte can have solubility to the non-aqueous solvent and exhibit desired metal ion conductivity. In general, a metal salt containing metal ions required to be conducted can be used.

For example, in the case of a lithium-air battery, as the second supporting electrolyte salt, a lithium salt can be used. Examples of the lithium salt include: inorganic lithium salts such as LiPF₆, LiBF₄, LiClO₄ and LiAsF₆; organic lithium salts represented by the above formula (1) such as LiCF₃SO₃; and organic lithium salts represented by the above formula (2) such as LiN(CF₃SO₂)₂, LiN(C₂F₅SO₂)₂ and LiC(CF₃SO₂)₃.

In the case of a sodium-air battery, sodium salts such as NaI, NaSCN, NaBr, NaClO₄, NaPF₆ and NaTFSA can be used. In the case of a potassium-air battery, potassium salts such as KClO₄, KSCN, KPF₆ and KTFSA can be used.

The aqueous liquid electrolyte is a solution in which the second supporting electrolyte salt is dissolved in water. The second supporting electrolyte salt in the aqueous liquid electrolyte can have water solubility and exhibit desired metal ion conductivity. For example, in the case of a lithium-air battery, lithium salts such as LiOH, LiCl, LiNO₃ and CH₃CO₂Li can be exemplified. In the case of a sodium-air battery, sodium salts such as NaCl, NaNO₃, NaOH and Na₂SO₄ can be exemplified. In the case of a potassium-air battery, potassium salts such as KCl, KNO₃, KOH and K₂SO₄ can be exemplified.

The non-aqueous liquid electrolyte and the aqueous liquid electrolyte can comprise a solid electrolyte. The solid electrolyte is not particularly limited, and can be appropriately selected according to the metal ion species to be conducted. Examples of the solid electrolyte include a sulfide-based inorganic solid electrolyte, an oxide-based inorganic solid electrolyte and a polymer electrolyte. Specific examples of the solid electrolyte include a Li—La—Ti—O based inorganic solid electrolyte; NASICON type inorganic solid electrolytes such as a Li—Al—Ge—(PO₄)₃ based inorganic solid electrolyte (LAGP) and a Li—Al—Ti—(PO₄)₃ based inorganic solid electrolyte (LATP); LiPON (lithium phosphorous oxynitride); a Li—La—Zr—O based garnet type inorganic solid electrolyte; and a PEO-TFSA(LiN(CF₃SO₂)₂) based polymer electrolyte.

From the viewpoint of surely preventing short circuit between the air cathode and the anode, the metal-air battery preferably comprises a separator for holding a liquid electrolyte between the air cathode layer and the anode layer. The separator can have insulation property and a porous structure capable of holding a liquid electrolyte, and the examples include a porous membrane of polyethylene, polypropylene or the like, a resin nonwoven fabric and a glass fiber nonwoven fabric.

A polymer is added to the non-aqueous liquid electrolyte or the aqueous liquid electrolyte for gelation to obtain an electrolyte gel. Using thus obtained electrolyte gel, an electrolyte layer can be formed. The polymer used for gelation of the liquid electrolyte varies depending on the types of the supporting electrolyte salt and solvent contained in the liquid electrolyte, and the examples include polyethylene oxide (PEO), polyacrylonitrile (PAN) and polymethylmethacrylate (PMMA).

The content of the second supporting electrolyte salt in the electrolyte layer is not particularly limited, and can be set in the general range. For example, the content of the second supporting electrolyte salt is preferably 0.5 to 1.2 mol, more preferably 0.6 to 1.2 mol, still more preferably 0.8 to 1.2 mol, with respect to 1 L of the liquid electrolyte. This is because if the amount of the second supporting electrolyte salt in 1 L of the liquid electrolyte is 0.5 mol or more, metal ion conductivity in the electrolyte layer can be sufficiently ensured, and if the amount of the second supporting electrolyte salt is 1.2 mol or less, high metal ionicity can be maintained.

In addition, the total of the amount (mol) of the first supporting electrolyte salt contained in the air cathode layer and the amount (mol) of the second supporting electrolyte salt contained in the electrolyte layer is preferably 0.6 to 3.0 mol, with respect to 1 L of the liquid electrolyte contained in the electrolyte layer. This is because if the total amount of the first supporting electrolyte salt and the second supporting electrolyte salt is 0.6 mol or more with respect to 1 L of the liquid electrolyte, it is possible to balance ensuring of metal ion conductivity in the electrolyte layer with improvement in capacity and durability, and if the total amount is 3.0 mol or less, the resistance inside the air cathode and the electrolyte and the resistance at the interface between the air cathode and the electrolyte layer can be controlled to prevent an excessive increase in resistance.

### 4. Others

The metal-air battery generally comprises a battery case for housing the air cathode, anode and electrolyte layer. The form of the battery case is not particularly limited, and the battery case may be in a coin form, a plate form, a cylinder form, a laminate form, etc. The battery case may be an open battery case or closed battery case. The open battery case has a structure in which at least the air cathode layer can be in full contact with the air. On the other hand, the closed battery case can be provided with an introduction tube and an exhaust tube for oxygen (air) being a cathode active material. The oxygen to be introduced preferably has a high concentration and is more preferably pure oxygen.

Each of the air cathode current collector and the anode current collector can be provided with a terminal which is a connection to the outside.

The method for producing the metal-air battery of the present invention is not particularly limited, and a general method can be employed.

### EXAMPLES

“mAh/g-Electrode” described below refers to discharged capacity per air cathode weight.

### Example 1

### (Production of Lithium-Air Battery)

A SUS 304 foil (anode current collector) and a lithium metal foil (anode layer) were stacked to produce an anode.

A liquid electrolyte was prepared by dissolving 1M of LiN(CF₃SO₂)₂ (hereinafter referred to as LiTFSA) in propylene carbonate. Thus prepared liquid electrolyte was impregnated with a nonwoven fabric made of polypropylene to produce an electrolyte layer.

To the mixture obtained by mixing carbon black (an electroconductive material), MnO₂ (a catalyst) and PVDF (a binder) in acetone at the weight ratio of 25:42:33, LiTFSA was added and mixed, thereby preparing an air cathode material mixture. The content of LiTFSA in the air cathode material mixture was set to the amount which allows the total of the amount of LiTFSA contained in the liquid electrolyte in the electrolyte layer and the amount of LiTFSA contained in the air cathode layer to be 1.25 mol per 1 L of the liquid electrolyte, that is, the content was set to the amount equivalent to 0.25 mol/L, which was a difference between the total amount of LiTFSA and the amount of LiTFSA in the liquid electrolyte. The obtained air cathode material mixture was applied on the surface of a carbon paper (an air cathode current collector) and dried to produce an air cathode in which the air cathode layer was formed on the air cathode current collector.

The electrolyte layer was interposed between an anode layer of the obtained anode and the air cathode layer of the air cathode to produce a lithium-air battery.

### (Evaluation of Lithium-Air Battery)

Using the obtained lithium-air battery, two cycles of charge and discharge were conducted as a pre-conditioning operation under pure oxygen (99.99%) atmosphere at 0.02 mA/cm² and 25° C. Then, a constant current charge-discharge cycle was conducted under the same condition.

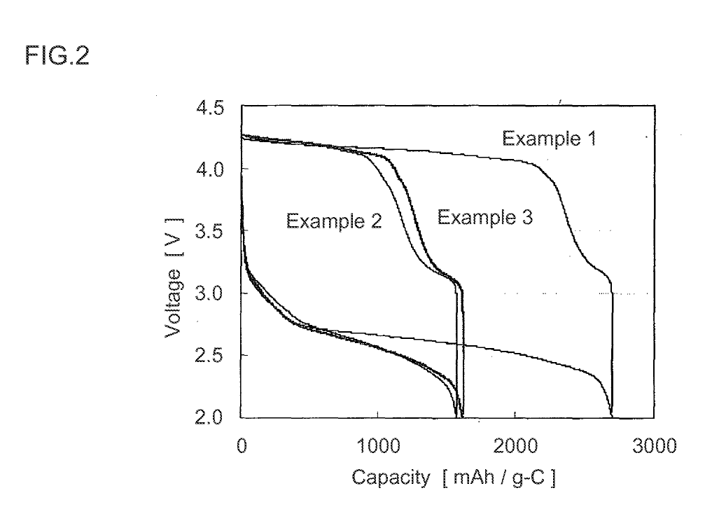

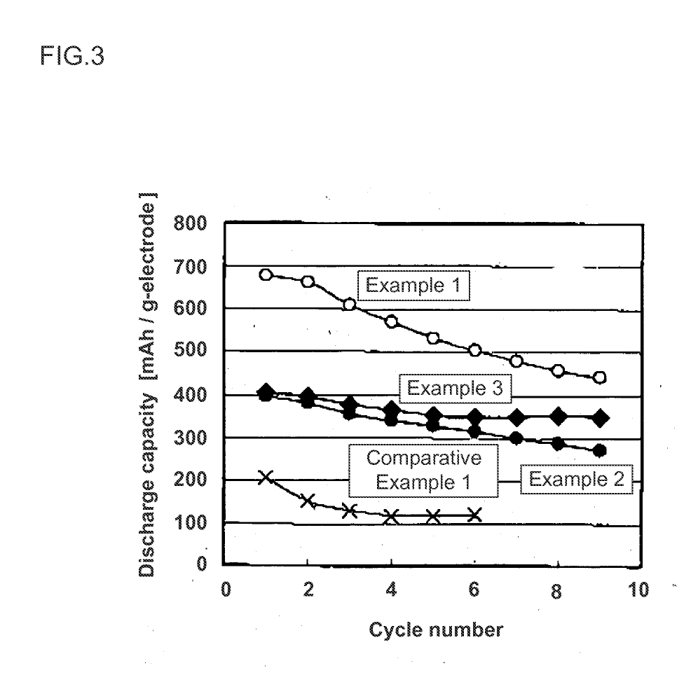

Charge-discharge curves in the first cycle of the constant current charge-discharge cycle, and constant current charge-discharge cycling performance (change in discharged capacity to the cycle number) are shown in FIGS. 2 and 3, respectively.

### Example 2

A lithium-air battery of Example 2 was produced similarly as in Example 1, except that an air cathode layer was formed using LiTFSA which is in an amount that allows the total of the amount of LiTFSA contained in the liquid electrolyte in the electrolyte layer and the amount of LiTFSA contained in the air cathode layer, to be 1.5 mol per 1 L of the liquid electrolyte.

Thus obtained lithium-air battery was evaluated similarly as in Example 1. The results are shown in FIG. 2 and FIG. 3.

### Example 3

A lithium-air battery of Example 3 was produced similarly as in Example 1, except that an air cathode layer was formed using LiTFSA which is in an amount that allows the total of the amount of LiTFSA contained in the liquid electrolyte in the electrolyte layer and the amount of LiTFSA contained in the air cathode layer, to be 2.0 mol per 1 L of the liquid electrolyte.

Thus obtained lithium-air battery was evaluated similarly as in Example 1. The results are shown in FIG. 2 and FIG. 3.

### Comparative Example 1

A lithium-air battery of Comparative Example 1 was produced similarly as Example 3 except that the lithium salt concentration of the liquid electrolyte in the electrolyte layer was set to 2.0M, and an air cathode layer was produced by mixing carbon black and Teflon (trade name) powders at the weight ratio of 90:10 without using a lithium salt and press molding the mixture. Thus obtained lithium-air battery was evaluated similarly as in Example 1. The result is shown in FIG. 3.

### [Evaluation Results]

As shown in FIG. 3, it can be understood from the comparison of Comparative Example and Examples that cycling performance and capacity of the metal-air battery (lithium-air battery) can be improved by preliminarily adding a Li salt being a supporting electrolyte salt in the air cathode. In particular, capacity each in Examples 1 to 3 was considerably increased compared to that in Comparative Example 1. Also, in Examples 12 and 3, especially in Example 3, a decrease in discharged capacity caused by the repetition of charge-discharge cycle was less likely to cause and durability was excellent, compared to Example 1.

In FIG. 2, initial capacity each in Examples 12 and 3 was decreased compared to that in Example 1 since a side reaction (a reaction of oxygen radicals and a solvent of propylene carbonate) was less likely to cause. Thereby, cycling performance each in Examples 12 and 3 was improved compared to that in Example 1.

### REFERENCE SIGNS LIST

1: Air cathode
2: Anode
3: Electrolyte layer
4: Air cathode current collector
5: Air cathode layer
6: Air cathode can
7: Anode can
8: Gasket
9: Air hole
10: Air-metal battery

1. An air cathode used for a metal-air battery comprising an air cathode, an anode and an electrolyte layer which is present between the air cathode and the anode and which conducts metal ions between the air cathode and the anode,
wherein the air cathode comprises an air cathode layer comprising at least an electroconductive material and a first supporting electrolyte salt.

2. The air cathode according to claim 1,
wherein the electrolyte layer comprises a liquid electrolyte comprising a second supporting electrolyte salt, and
wherein the air cathode layer contains 0.05 to 2.5 mol of the first supporting electrolyte salt with respect to 1 L of the liquid electrolyte contained in the electrolyte layer.

3. A metal-air battery comprising an air cathode, an anode and an electrolyte layer which is present between the air cathode and the anode and which conducts metal ions between the air cathode and the anode,
wherein the air cathode comprises an air cathode layer comprising at least an electroconductive material and a first supporting electrolyte salt, and
wherein the electrolyte layer comprises a liquid electrolyte comprising a second supporting electrolyte salt.

4. The metal-air battery according to claim 3,
wherein the air cathode layer contains 0.05 to 2.5 mol of the first supporting electrolyte salt with respect to 1 L of the liquid electrolyte contained in the electrolyte layer, and
wherein the electrolyte layer contains 0.5 to 1.2 mol of the second supporting electrolyte salt with respect to 1 L of the liquid electrolyte contained in the electrolyte layer.

5. The metal-air battery according to claim 4, wherein the total amount of the first supporting electrolyte salt contained in the air cathode layer and the second supporting electrolyte salt contained in the electrolyte layer [(the molar number of the first supporting electrolyte salt)+(the molar number of the second supporting electrolyte salt)] is 0.6 to 3.0 mol, with respect to 1 L of the liquid electrolyte contained in the electrolyte layer.

6. A method for producing an air cathode for a metal-air battery, comprising the steps of:
preparing an air cathode material mixture by mixing at least a supporting electrolyte salt, an electroconductive material and a solvent; and
evaporating to dryness of the supporting electrolyte salt by drying the air cathode material mixture.
